(19) United States
(12) Patent Application Publication
(10) Pub. No.: US 2006/0090950 A1
(43) Pub. Date: May 4, 2006

(54) High-rise go-chart chassis

(76) Inventor: Stanley Krise, Addison, NY (US)

Correspondence Address: GREENBERG & LIEBERMAN, LLC, 2141 WISCONSIN AVE, N.W., SUITE C-2, WASHINGTON, DC, 20007, US

(21) Appl. No.: 10/975,628

(22) Filed: Oct. 28, 2004

(51) Int. Cl. B62D 21/00

(52) U.S. Cl. 180/311

(57) ABSTRACT

A go-cart chassis that sits lower on the front right side than the rest of the chassis to promote weight shifting to the front right tire of an attached right front tire. The go-cart chassis also has a raised rear portion such that the weight of the chassis sits atop a received rear axel to promote extra weight atop the rear axel for better tire grip. The raised rear portion also promotes better acceleration with better forward bite. A smaller diameter chassis tubing promotes flexing of the chassis, and a sloping mid section angles a motor for lower oil consumption.

### FIELD OF THE INVENTION

A chassis for motorized vehicles racing on dirt surfaces is described. More specifically, the present invention is a chassis that varies from the flat, horizontal conventional chassis design to provide a better grip or wedge when racing on dirt.

### BACKGROUND OF THE INVENTION

Go-cart racing is much more than simply moving a go-cart around an oval or elliptical track. In fact, the management of weight and engine efficiency makes go-cart racing an art unto itself.

When one wants to modify the weight displacement and engine efficiency of a go-cart, one is really referring to modifying the chassis. It is the chassis of the go-cart that determines how weight is shifted as the go-cart moves around a track. Moreover, it is the chassis of the go-cart that affects the position in which the engine is held.

Conventional go-cart chassis are horizontal, such that front and rear axels are disposed above the chassis. In addition, conventional go-cart chassis are rather symmetric along a centerline separating the left side of a chassis from the right side of a chassis. Also, conventional chassis generally do not flex much because they are designed to provide support.

Conventional go car chassis often have large tubing, and while larger individuals will be able to force chassis with larger tubing along surfaces, smaller individuals and children will not create enough force to effectively race these go-carts. In recent years, the starting age of a go-cart racer has been getting younger and younger, and it's important to design go-cart chassis that will work well for any age. Unlike the present invention, traditional go-cart chassis do not provide smaller tubing for smaller individuals, while still providing bigger tubing as the individual graduates to a bigger size.

Unfortunately, conventional go-cart chassis are really designed for hardtop racing, whereas much of the control and focus of go-cart racing on dirt surfaces does not depend upon a straightaway. The key to successful go-cart racing on dirt surfaces is controlling the go-cart during turns, and the conventional go-cart chassis falters in this regard. When the go-cart traverses a turn, the go-cart typically tries to grip the dirt surface.

Conventional chassis do not assist the go-cart in gripping the dirt surface enough to prevent loss of traction. Moreover, conventional chassis do not assist whatsoever with steering of the go-cart. Also, conventional go-cart chassis are unable to flex to allow weight shifting during turns.

Thus, there is a need for a go-cart chassis that is flexible, but still supporting. Further, there is a need for a go-cart chassis that allows easier steering during turns, and there is a need for a chassis that can shift engine position to allow it to run more efficiently.

### SUMMARY OF THE INVENTION

The present invention is an asymmetrical go-cart chassis with a front right end sitting lower than the rest of the chassis. The front right end being lower automatically builds wedge into the cart for traversing the turns. “Wedge” means adding weight to the right front and left rear of the cart.

The tubing of the chassis is of smaller diameter that a typical chassis to promote flex and responsiveness to weight displacement as the chassis enters and exits a turn. Furthermore, the smaller diameter of the tubing functions to allow smaller individuals, particularly 150 pounds and below, to successfully ride on any surface because they can provide the requisite force necessary to move the go-cart. As a person graduates to a different size, the tubing size will get larger in order to account for the amount of force the individual can exert. There is further extra support toward the front of the chassis to prevent structural integrity from being compromised because extra weight is placed upon the front right of the chassis.

The present invention also has a right mid section, which tilts the engine forward from the horizontal plane. This allows the engine to run with less oil.

Additionally, the present invention sits above the rear axel, unlike conventional chassis for go-carts. This feature gives more ground clearance, and with the frame flex of the high-rise chassis, more forward bite. “Forward bite” means that the power rear wheels have more traction to move the vehicle forward.

### BRIEF DESCRIPTION OF THE DRAWINGS

FIG. 1 shows an environmental perspective view of the present invention.

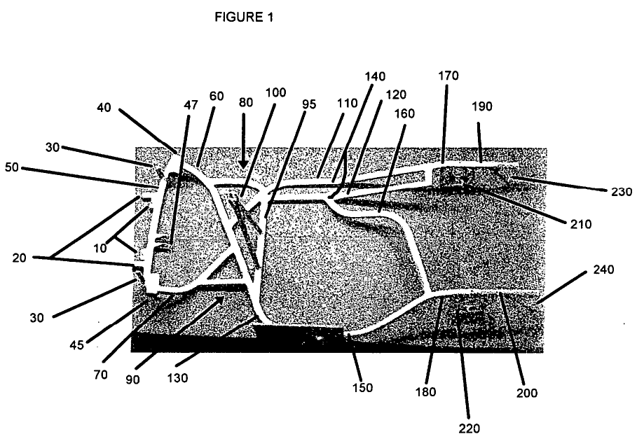

### DETAILED DESCRIPTION OF THE PREFERRED EMBODIMENT

The present invention has a chassis that raises the center of gravity of a go-cart and forces weight of the go-cart to the tires of a typical go-cart. While the go-cart's tires obviously grip on a dirt surface, increased speed and severity of turns force the tires to lose grip. The present invention uses displacement of the weight of the go-cart, via the chassis, to allow the weight of the go-cart to shift towards the right front wheel of the go-cart. Thus, on turns to the left, the go-cart has greater stability. This means that the tires grip and do not slide—in the field this is referred to as better “bite.” The present invention also provides better ground clearance than the typical go-cart chassis because it is elevated in towards its rear. This is important because ripples in the dirt elevation of a typical dirt go-cart track can easily contact and damage the bottom of a go-cart.

The present invention has several conventional adaptations, and they are common to the go-cart chassis art. For example, two tabs (10) that are conventionally disposed for brake and throttle attachment. Forward poles (20) and upright poles (30) are for conventional bumper mounting. Also, right front spindle (40) and left front spindle (45) are for conventional attachment of the two front tires of a go-cart. Two protrusions (47) extending toward the center of the chassis are for a conventional steering wheel mount. Front bar (50) serves as a point of attachment for two tabs (10), forward poles (20), upright poles (30), right front spindle (40), left front spindle (45), and two protrusions (47).

Importantly, right front spindle (40) sits ½ inch lower than left front spindle (45) and 3″ higher than the plain of the center of the chassis. The left front spindle (45) raises 3.5″ above the plain of the center of the chassis. Because most of the weight of a go-cart is on its front two tires, it is advantageous to create a “wedge” in the car. That is, as a go-cart goes around a typical oval track, and makes left turns, the wedge forces weight to the right front tire. On straight away, the go-cart with the chassis of the present invention automatically turns left because of the lower displacement of right front spindle (40). This helps the go-cart to navigate the turn better; or in other words, helps the right front tire dig into the dirt on the turn because the right front tire has more weight of the chassis bearing down on it.

Right front side rail (60) extends from the right front spindle (40) and traverses the width of the chassis until it bends to form the left mid side rail (130). Further, the right front side of the rail (60) attaches to the right front spindle (40) with a 60-degree bend and a drop towards the left mid side of the rail (130). Similarly, but slightly differently, the left front side of the rail (70) traverses to the mid center of the chassis where it reaches the right mid side of the rail (110). The left front side of the rail (70) is broken in its traversing of the chassis by the right front side of the rail (60). The second portion of the left front side of the rail (70) is shifted forward as it traverses the width of the chassis. This is done to provide extra structural support to the right front of the chassis because it will have a large portion of the go-cart's weight bearing down upon it, as well as to promote flexing. Right sub support rail (80) and left sub support rail (90) help to provide structural integrity as the right front side of the rail (60) and the left front side of the rail (70) crisscross. The Mid section has more support on right than left because the chassis has the weight falling toward the right side of vehicle, and a fixed direct support runs from the front right toward the back left because this is the line at which the weight will be disposed downward toward the right side of the vehicle. Cross bar (95) connects the rear end of the right front side of the rail (60) with the rear end of the left front side of the rail (70). This also provides upright structural support for the conventional steering wheel support (100).

The mid section of the present invention has a right mid side of the rail (110), and parallel and adjacent to it, a secondary right mid side of the rail (120). Together, the right mid side of the rail (110) and the secondary right mid side of the rail (120) support a conventional motor. The motor simply bolts there securely. The duality of the right mid side of the rail (110) and the secondary right mid side of the rail (120) allows a mounting surface.

At elevation point (140) on the right side of the chassis, as well as at secondary elevation point (150) on the left side of the chassis, the chassis elevates upward at a 16-degree slope from the horizontal plane. There are two reasons for the 16-degree slope. First, the rear of a convention motor is tilted forward at a 16-degree angle, which allows the user to run less oil in the conventional motor and still oil the motor properly. While the preferred embodiment is 16 degrees, any angle of tilt will suffice in furtherance of the principles of the present invention. Second, it is desirable to have a raised rear portion of the chassis and an installation of a rear axel under the frame for better clearance of ground objects, as well as to shift rear weight toward the front of the chassis. Further, at the secondary elevation point (150) the left side of the chassis bends inward at a 18° bend.

The left mid side of the rail (130) loops out at a 60° bend past the rest of the left side of the chassis to accommodate a conventional go-cart seat. Rear cross bar (160) provides structural support for the chassis by running from the secondary right mid side of the rail (120) to the left mid side of the rail (130). There is a bend in rear cross bar (160) to accommodate and not interfere in the path of the chain of a conventional motor that runs to a conventional rear axel. The current embodiment of the invention has the rear cross bar (160) bending twice, first at a 45° slope downwards from the right mid side of the rail (120) to the a first point in the rear cross bar (163), and second at a 70° slope downwards from a second point in the rear cross bar (167) to the left terminus point (180).

The 16-degree slope ends at right terminus point (170) and left terminus point (180), where the right mid side of the rail (110) and the secondary right mid side of the rail (120) meet. In order to straighten the left rear side of the rail (200), the left rear side of the rail must bend 28° at the left terminus point (180). Thereafter, the rear right side of the rail (190) and the left rear side of the rail (200) extend, respectively. A conventional rear axel is received by the chassis at right rear axel bearing housing (210) and left rear axel bearing housing (220). Unlike a conventional chassis, at right rear axel bearing housing (210) and left rear axel bearing housing (220) are disposed underneath the rear right side of the rail (190) and left rear side rail (200). This, again, promotes ground clearance and forward acceleration.

To create a wedge, the goal is to drop either right front or rear left side of the chassis. But, it is too hard to adjust the grip or wedge on back left end of the vehicle (as the go-cart is rear wheel drive). So to have a push on the left rear and create wedge is difficult because if you drop the rear left too far, the user creates too much wedge and the go-cart drives on its left tire only. Whereas, in the present invention, displacing more weight on the front right tire, the user can turn a conventional steering wheel to compensate for too much weight on the wedge, if such occurs.

The chassis going over the rear axel rather than under provides the chassis with the ability to flex under weight and drive the rear tires farther into the ground, as opposed to the chassis and weight merely sitting underneath the axel.

Right rear bumper mount (230) and left rear bumper mount (240) are conventional bumper mounts.

The present invention is not limited to the embodiments herein described, but in addition, includes all embodiments within the scope of the following claim.

I claim:

1. A chassis for a go-cart, comprising:
a front right side; and
a front left side in communication with said front right side.

2. The device of claim 1, wherein said front right side is in a first horizontal plane.

3. The device of claim 1, wherein said front left side is adjacent to said front right side.

4. The device of claim 2, wherein said front left side is in a second horizontal plane.

5. The device of claim 4, wherein said first horizontal plane is lower than said second horizontal plane.

6. The device of claim 1 further comprising a rear right side in communication with said chassis;
a first port in communication with said rear right side;
a rear right axel in communication with said first port;
a rear left side;
a second port in communication with said rear left side; and
a rear left axel in communication with said second port.

7. The device of claim 6, wherein said rear right side is above said first port.

8. The device of claim 6, wherein said first port receives said rear right axel.

9. The device of claim 6, wherein said rear left side is above said second port.

10. The device of claim 6, wherein said second port receives said rear left axel.

11. The device of claim 1 further comprising a right mid side in communication with said chassis;
a left mid side in communication with said chassis; and
a rear cross bar in communication with said right mid side and left mid side.

12. The device of claim 11, wherein said right mid side is disposed at an upward slope from said front right side to said rear right side.

13. The device of claim 11, wherein said rear cross bar bends from said right mid side to said left mid side.
